(19) United States
(12) Patent Application Publication
(10) Pub. No.: US 2025/0119989 A1
(43) Pub. Date: Apr. 10, 2025

(54) MICROWAVE OVEN AND METHOD FOR OPERATION

(71) Applicant: Haier US Appliance Solutions, Inc., Wilmington, DE (US)

(72) Inventors: Karen Edberg, Louisville, KY (US); Mark Heimerdinger, Louisville, KY (US)

(21) Appl. No.: 18/481,611

(22) Filed: Oct. 5, 2023

(51) Int. Cl. H05B 6/64

(52) U.S. Cl. CPC H05B 6/6447

(57) ABSTRACT

A microwave oven appliance having a non-inverter power supply and a controller for operation is provided. A method for operation of a microwave oven appliance is provided, the method including measuring a received line voltage at a non-inverter power supply; determining a baseline output energy generated relative to a nominal line voltage; determining an actual output power relative to the received line voltage; determining a duty cycle adjustment based on the actual output power relative to the received line voltage; and reducing or increasing magnetron ON time based on the duty cycle adjustment.

### FIELD OF THE INVENTION

The present disclosure relates generally to microwave oven appliances and methods for operation therefor.

### BACKGROUND OF THE INVENTION

Microwave oven appliances generally do not regulate output power across the entire 120VAC line voltage range. The output power can vary significantly depending upon the exact voltage at the appliance. For instance, voltage at a location (e.g., residence, house, etc.) may vary due to conditions at the utility grid, such as differences relating to time of day (e.g., daytime versus nighttime conditions), season (e.g., high or low temperature conditions versus moderate temperatures, wind or sunlight conditions, etc.).

Microwave oven appliances may generally be configured to operate within a range above and below a specified voltage (e.g., within a range above and below 120 VAC). However, power ratings and cooking performance are generally optimized for the specified voltage, rather than the operating range. As a result, changes in received line voltage at the microwave oven appliance may result in undesired changes in power output. At high and low voltages within the operating range, microwave features, such as operating modes for cooking popcorn, melting butter, or defrosting foods, may have reduced or compromised performance when the voltage at the microwave oven is off of the specified voltage (e.g., above or below 120 VAC).

Accordingly, a microwave oven appliance and method for operation addressing one or more of these issues would be beneficial and advantageous.

### BRIEF DESCRIPTION OF THE INVENTION

Aspects and advantages of the invention will be set forth in part in the following description, may be apparent from the description, or may be learned through practice of the invention.

An aspect of the present disclosure is directed to a microwave oven appliance including a non-inverter power supply configured to receive a nominal line voltage. The power supply includes a relay configured to articulate operation a magnetron. A sensor is operably coupled to the power supply to determine received line voltage. A controller is operably coupled to the power supply and the sensor, the controller configured to store instructions that, when executed, causes the microwave oven appliance to perform operations. The operations include measuring the received line voltage at the power supply; determining a baseline output energy generated relative to the nominal line voltage; determining an actual output power relative to the received line voltage; determining a duty cycle adjustment based on the actual output power relative to the received line voltage; adjusting the duty cycle based on the duty cycle adjustment to reduce magnetron ON time when the received line voltage is greater than the nominal line voltage; adjusting the duty cycle based on the duty cycle adjustment to increase magnetron ON time when the received line voltage is less than the nominal line voltage; and maintaining the duty cycle without adjustment when the line voltage received is equal to the nominal line voltage.

An aspect of the present disclosure is directed to a method for operating a microwave oven appliance including a non-inverter power supply. The method includes measuring a received line voltage at a non-inverter power supply; determining a baseline output energy generated relative to a nominal line voltage; determining an actual output power relative to the received line voltage; determining a duty cycle adjustment based on the actual output power relative to the received line voltage; and reducing or increasing magnetron ON time based on the duty cycle adjustment.

An aspect of the present disclosure is directed to a controller for a microwave oven appliance. The controller is operably coupled to a non-inverter power supply and a sensor configured to determine received line voltage. The controller is configured to store instructions that, when executed, causes the microwave oven appliance to perform operations. The operations include measuring a received line voltage at a non-inverter power supply; determining a baseline output energy generated relative to a nominal line voltage; determining an actual output power relative to the received line voltage; determining a duty cycle adjustment based on the actual output power relative to the received line voltage; and reducing or increasing magnetron ON time based on the duty cycle adjustment.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary embodiment of a microwave oven appliance in accordance with aspects of the present disclosure;

FIG. 2 provides a perspective view, with door open, of an exemplary embodiment of a microwave oven appliance in accordance with aspects of the present disclosure;

FIG. 3 provides an electrical diagram of an exemplary embodiment of a power supply for a microwave oven appliance in accordance with aspects of the present disclosure;

FIG. 4 provides a graph depicting an exemplary duty cycle of the power supply for a microwave oven appliance in accordance with aspects of the present disclosure;

FIG. 5 provides a graph depicting an exemplary regulation curve of the power supply for a microwave oven appliance in accordance with aspects of the present disclosure;

FIG. 6A provides a graph depicting an exemplary duty cycle of the power supply for a microwave oven appliance in accordance with aspects of the present disclosure;

FIG. 6B provides graphs depicting an exemplary duty cycle of the power supply for a microwave oven appliance in accordance with aspects of the present disclosure;

FIG. 7 provides a graph depicting an exemplary duty cycle of the power supply for a microwave oven appliance in accordance with aspects of the present disclosure;

FIG. 8 provides a graph depicting an exemplary table of operation of the power supply by power level for a microwave oven appliance in accordance with aspects of the present disclosure;

FIG. 9A provides a graph depicting an exemplary duty cycle of the power supply for a microwave oven appliance in accordance with aspects of the present disclosure;

FIG. 9B provides a graph depicting an exemplary duty cycle of the power supply for a microwave oven appliance in accordance with aspects of the present disclosure; and

FIG. 10 provides a flowchart outlining steps of a method for operation of a microwave oven appliance in accordance with aspects of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of the present disclosure are referenced throughout this document with regard to a microwave oven appliance. The reference to a microwave is for illustration, not limitation. Accordingly, embodiments of the microwave oven depicted and described herein may include any appropriate configuration of microwave oven appliance, without limitation to, e.g., an over-the-range (OTR) microwave appliance, as may be depicted and described herein.

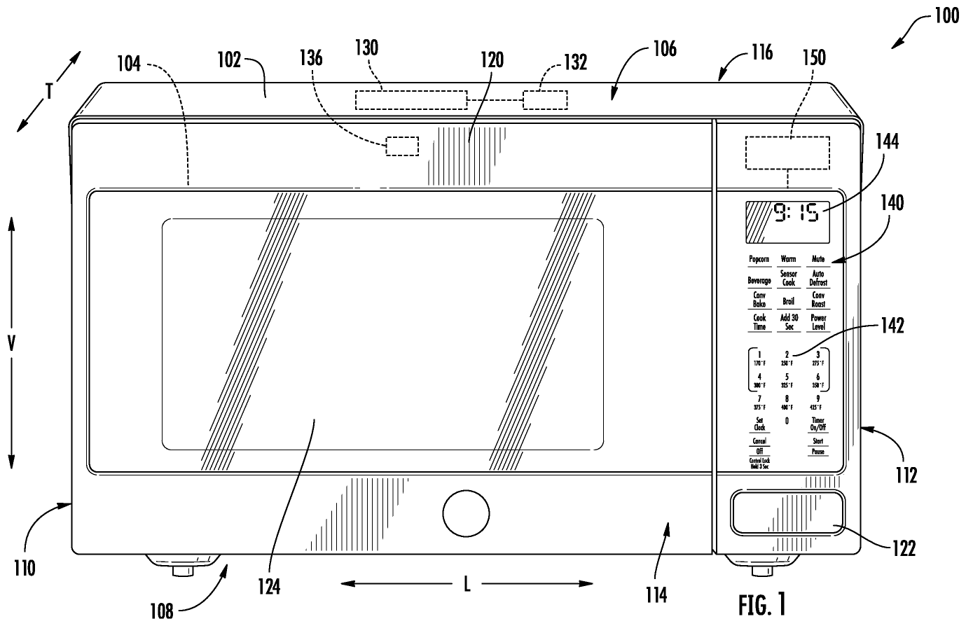

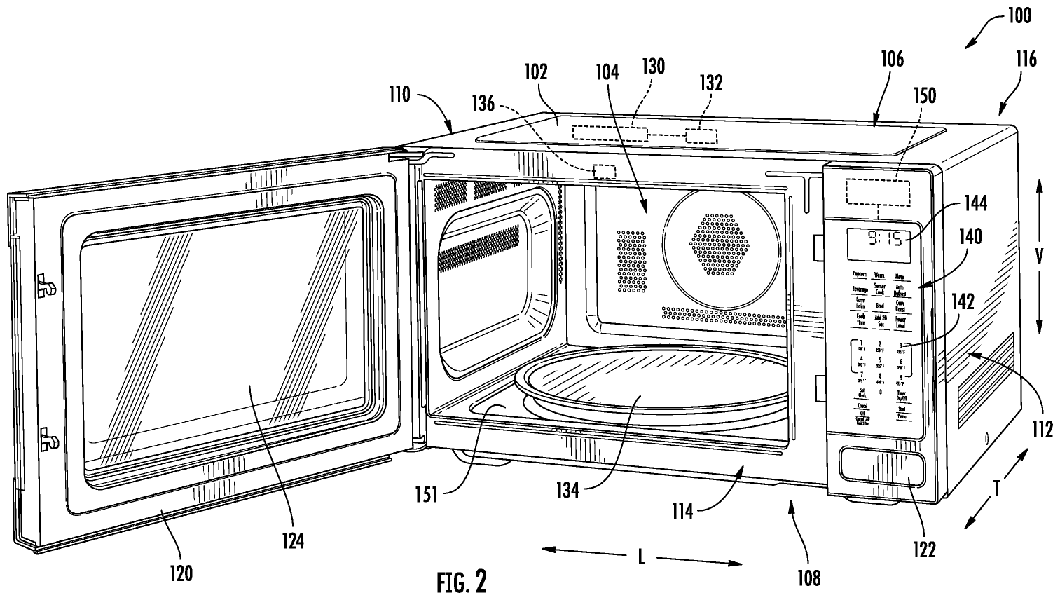

Referring now to the figures, FIG. 1 provides a front view of a microwave oven appliance 100 according to one or more exemplary embodiments of the present subject matter and FIG. 2 provides a perspective view of the microwave oven appliance 100 with the door in an open position. In some embodiments, the microwave oven appliance 100 may include an insulated cabinet 102 that may define a cooking chamber 104 for receipt of food items for cooking. As will be understood by those skilled in the art, the microwave oven appliance 100 may be provided by way of example only, and the present subject matter may be used in any suitable microwave oven appliance, such as a countertop microwave oven appliance, an over-the-range microwave oven appliance, etc. Thus, the exemplary embodiment shown in the figures is not intended to limit the present subject matter in any respect, e.g., the present subject matter is not limited to any particular cooking chamber configuration or arrangement.

As illustrated, the microwave oven appliance 100 may generally define a vertical direction V, a lateral direction L, and a transverse direction T, each of which being mutually perpendicular, such that an orthogonal coordinate system may generally be defined. The cabinet 102 of microwave oven appliance 100 may extend between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

The microwave oven appliance 100 may include a door 120 that may be rotatably attached to cabinet 102 in order to permit selective access to cooking chamber 104. In some embodiments, such as FIGS. 1 and 2, the microwave oven appliance 100 may include a door release button 122 that disengages or otherwise pushes open the door 120 when depressed. Glass windowpanes 124 may be provided for viewing the contents of cooking chamber 104 when door 120 is closed and may also assist with insulating cooking chamber 104.

Alternatively, in some embodiments, that microwave oven appliance 100 may include a handle that may be mounted to door 120, for example, to assist a user with opening and closing door 120 in order to access cooking chamber 104. For example, in such embodiments, a user may pull on the handle to open the door 120 and access cooking chamber 104.

In some embodiments, the microwave oven appliance 100 may include additional features to improve heating uniformity and precision. For example, according to an exemplary embodiment, microwave oven appliance 100 may include a turntable 134 that may be rotatably mounted within cooking chamber 104. The turntable 134 may be selectively rotated during a cooking process to ensure improved temperature uniformity for the object being heated.

In some embodiments, the microwave oven appliance 100 may also include a user interface panel 140 and a user input device 142 that may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical, or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, the microwave oven appliance 100 may include a controller 150 that may be in operative communication with the user input device 142. The user interface panel 140 of the microwave oven appliance 100 may be in communication with the controller 150 via, for example, one or more signal lines or shared communication busses, and signals generated in controller 150 operate microwave oven appliance 100 in response to user input via the user input devices 142. Input/Output (“I/O”) signals may be routed between controller 150 and various operational components of the microwave oven appliance 100. Operation of the microwave oven appliance 100 may be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of the microwave oven appliance 100, and the controller 150 is not restricted necessarily to a single element. The memory may represent random access memory such as DRAM, static random access memory such as SRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Microwave oven appliance 100 may generally be configured to heat articles, for example, food items such as food or beverages, within cooking chamber 104 using electromagnetic radiation. The microwave oven appliance 100 may include various components which operate to produce the electromagnetic radiation. For example, the microwave oven appliance 100 may include a microwave heating assembly 130 which may include a magnetron configured to convert energy to electromagnetic radiation, specifically microwave radiation. The microwave heating assembly 130 is operably coupled to a power supply 132, such as a High Voltage Transformer (HVT). The power supply 132 is configured to generate an output voltage to power the microwave heating assembly 130, such as configured as a magnetron. In various embodiments, microwave oven appliance 100 includes a sensor 136 configured to determine an actual line voltage received at the power supply 132.

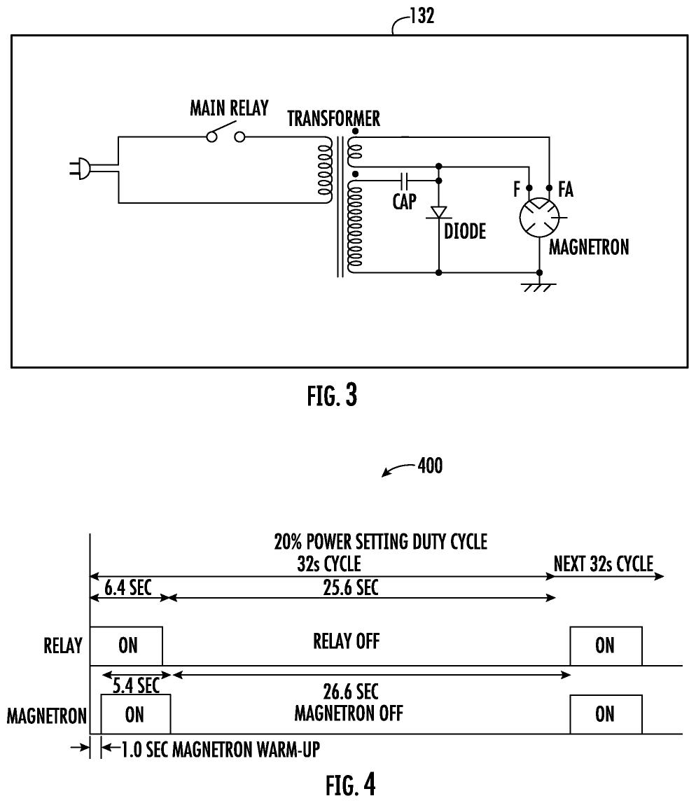

Referring briefly to FIG. 3, the power supply 132 may include a transformer 232, a capacitor 234, a diode 236, and a relay 238. The power supply 132 may be configured to receive a nominal line voltage. For instance, the nominal line voltage may correspond to a residential line voltage supply of 120 VAC. However, an actual line voltage supply received at the microwave oven appliance 100 may be greater or lesser than the nominal line voltage within a voltage range. For instance, the microwave oven appliance 100 may be configured to receive an actual voltage within a voltage range of the nominal line voltage +10%, −15% (e.g., a range between 102 VAC and 132 VAC).

It should be appreciated that the nominal line voltage may correspond to any line voltage supply, such as, but not limited to, 100V, 110V, 115V, 127V, 220V, 230V, 240V, etc. Additionally, it should be appreciated that the voltage range may vary based on the utility grid from which the line voltage is provided, and embodiments of the microwave oven appliance may be configured to receive a voltage range corresponding to the voltage range corresponding to the utility grid from which the line voltage is received.

As actual voltage received at the microwave oven appliance 100 fluctuates (i.e., line voltage greater than or less than the nominal line voltage), voltage output from the power supply 132 also fluctuates when the power supply 132 is configured as non-adjustable or fixed relative to the received line voltage, such as when configured as a non-inverter power supply (e.g., High Voltage Transformer). Non-inverter power supplies generally generate an electric field intensity of either one hundred percent (100%) or zero percent (0%). A user or a cooking program may adjust a power level at the microwave oven appliance 100, and the power level is adjusted using a timed duty cycle. For example, FIG. 4 provides an exemplary graph 400 depicting a duty cycle at a twenty percent (20%) power level (e.g., PL2) for the microwave heating element 130 configured with a thirty-two (32) second magnetron timing cycle. FIG. 8 furthermore provides an exemplary table 800 depicting relay ON/OFF times and magnetron ON/OFF times relative to commanded power level and actual power level. At PL2, the relay 238 closes for 6.4 seconds to turn ON the magnetron and opens for 25.6 seconds to turn OFF the magnetron. In the exemplary embodiment, the magnetron has a one-second warm-up before generating energy. Accordingly, an actual magnetron ON time at PL2 is 5.4 seconds and the OFF time is 26.6 seconds. The duty cycle may repeat for the entire cook time commanded by the user or the cooking program.

Referring to FIG. 10, a flowchart outlining steps for a method for operating a microwave oven appliance is provided (hereinafter, “method 1000”). Embodiments of the method 1000 include methods for energy compensation for microwave oven appliances including heating assemblies operated from non-inverter power supplies, such as described herein. Steps of the method 1000 provided herein may be stored, all or in part, as instructions that, when executed, causes the appliance to perform operations. For instance, steps of method 1000 may be stored at a controller (e.g., controller 150) as instructions that, when executed, causes the microwave heating assembly (e.g., microwave heating assembly 130) and power supply (e.g., power supply 132) to perform operations, such as described herein. While embodiments of a microwave oven appliance are provided herein, it should be appreciated that various embodiments of the method 1000 may be performed at other configurations of microwave oven appliance including a non-inverter power supply.

Embodiments of the method 1000 include at 1010 determining a baseline output energy generated relative to a nominal line voltage. Step 1010 may include determining a sum of magnetron total ON time relative to a cook time and converting the sum of magnetron ON time to a unit of energy. Step 1010 may include a function of baseline output energy and percentage output power from a regulation curve.

Method 1000 includes at 1015 measuring, calculating, or otherwise determining a line voltage received at the power supply (received line voltage), such as via sensor 136.

Embodiments of the method 1000 may include at 1020 determining a regulation curve including a function of output power to received line voltage. Step 1020 may include at 1022 measuring, calculating, or otherwise determining a line voltage received at the power supply, such as via sensor 136. Determining the regulation curve may include extrapolating, interpolating, or performing a regression to determine output power versus line voltage. In various embodiments, the regulation curve may be stored as a chart, table, graph, schedule, equation, etc. at controller 150.

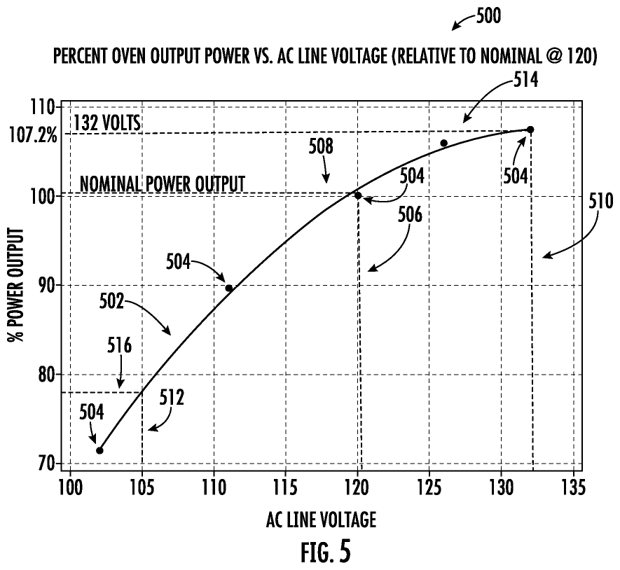

Referring briefly to FIG. 5, an exemplary graph 500 depicting a regulation curve 502 is provided. The regulation curve 502 may be determined from a plurality of measurements, calculations, or other determinations, such as depicted at point(s) 504. In an exemplary embodiment at which nominal line voltage is 120 VAC, such as depicted at line 506, a nominal power output is 100% (e.g., PL10), such as depicted at line 508. As described herein, actual line voltage received at the power supply (e.g., power supply 132) may fluctuate, such as greater than nominal line voltage (e.g., depicted at line 510) or less than the nominal line voltage (e.g., depicted at line 512). Actual output power corresponds to the received line voltage. For instance, actual output power relative to a received line voltage greater than nominal 510 is greater than the nominal power output, such as depicted at line 514. Actual output power relative to a received line voltage less than nominal (such as depicted at line 512) is less than the nominal power output, such as depicted at line 516.

Method 1000 includes at 1030 determining an actual output power, or percentage difference from nominal line voltage, relative to the received line voltage. Method 1000 at 1030 may include comparing the received line voltage to the regulation curve to determine the actual output power relative to the received line voltage. Determining the actual output power may include determining a predicted or calculated actual output power.

Method 1000 includes at 1040 determining a duty cycle adjustment based on the actual output power relative to the received line voltage. Method 1000 includes at 1042 adjusting the duty cycle based on the duty cycle adjustment. Adjusting the duty cycle based on the duty cycle adjustment may include at 1044 adjusting the duty cycle to reduce magnetron ON time when the line voltage received is greater than the nominal line voltage (e.g., greater than 120 VAC), or at 1046 adjusting the duty cycle to increase magnetron ON time when the line voltage received is less than the nominal line voltage (e.g., less than 120 VAC). The method 1000 may include at 1048 maintaining the duty cycle without adjustment when the line voltage received is equal to the nominal line voltage.

Referring still to FIG. 5, in an exemplary embodiment, a cooking program includes a two-minute (e.g., one-hundred and twenty (120) seconds) cook time relative to a nominal line voltage of 120 VAC at 100% power level (PL10), such as depicted at line 506. Method 1000 at 1010 determines a baseline output energy of 2.0magnetron-minutes relative to 120 VAC (e.g., 2.0 minutes×100% magnetron power). Method 1000 at 1015 determines (e.g., via sensor 136) a received line voltage of 132 VAC, such as depicted at line 510. Method 1000 at 1030 determines (e.g., via the regulation curve) an actual output power as 107.2% of nominal line voltage, such as depicted at line 514. Method 1000 at 1040 determines a duty cycle change based on the actual output power, such as by dividing the baseline output energy (e.g., 2.0 magnetron-minutes) by the actual output power percentage (e.g., 107.2%) to obtain the duty cycle change of 1.87 magnetron-minutes relative to 132 VAC. Method 1000 at 1044 adjusts the duty cycle to reduce magnetron ON time from 2.0 minutes (120 seconds) to 1.87 minutes (112 seconds).

Referring still to FIG. 5, in another exemplary embodiment, a cooking program includes a two-minute (e.g., one-hundred and twenty (120) seconds) cook time relative to a nominal line voltage of 120 VAC at 100% power level (PL10). Method 1000 at 1010 determines a baseline output energy of 2.0 magnetron-minutes relative to 120 VAC (e.g., 2.0 minutes×100% magnetron power). Method 1000 at 1015 determines (e.g., via sensor 136) a received line voltage of 105 VAC, such as depicted at line 512. Method 1000 at 1030 determines (e.g., via the regulation curve) an actual output power as 76.9% of nominal line voltage, such as depicted at line 516. Method 1000 at 1040 determines a duty cycle change based on the actual output power, such as by dividing the baseline output energy (e.g., 2.0 magnetron-minutes) by the actual output power percentage (e.g., 76.9%) to obtain the duty cycle change of 2.6 magnetron-minutes relative to 105 VAC. Method 1000 at 1046 adjusts the duty cycle to increase magnetron ON time from 2.0 minutes (120 seconds) to 2.6 minutes (156 seconds).

Referring to the exemplary embodiments, method 1000 may include at 1005 receiving a commanded cook time (e.g., 120 seconds). In various embodiments, the microwave oven appliance 100 may display the commanded cook time (e.g., 120 seconds) at the display component 144 while reducing or increasing magnetron ON time (e.g., from 120 seconds to 112 seconds or 156 seconds). Keeping the cook time unchanged at the display component 144 may avoid user confusion. For instance, keeping a displayed cook time unchanged from the commanded cook time (e.g., 120 seconds), in contrast to adjusting the displayed cook time to the adjusted duty cycle, while adjusting the magnetron ON time may allow for adjustments to the duty cycle without appearing to override the user command for a 120 second cook time. For the user, the cook time may appear unchanged (e.g., 120 seconds) while each usage of the microwave oven appliance 100 adjusts the duty cycle to generate a consistent result relative to the commanded cook time. Accordingly, a user that may be accustomed to a result relative to a commanded cook time (e.g., 120 seconds) may receive consistent results by adjusting the duty cycle relative to the received line voltage. In still various embodiments, a communication signal may be provided to the display component 144 to inform the user that the cook time is adjusted.

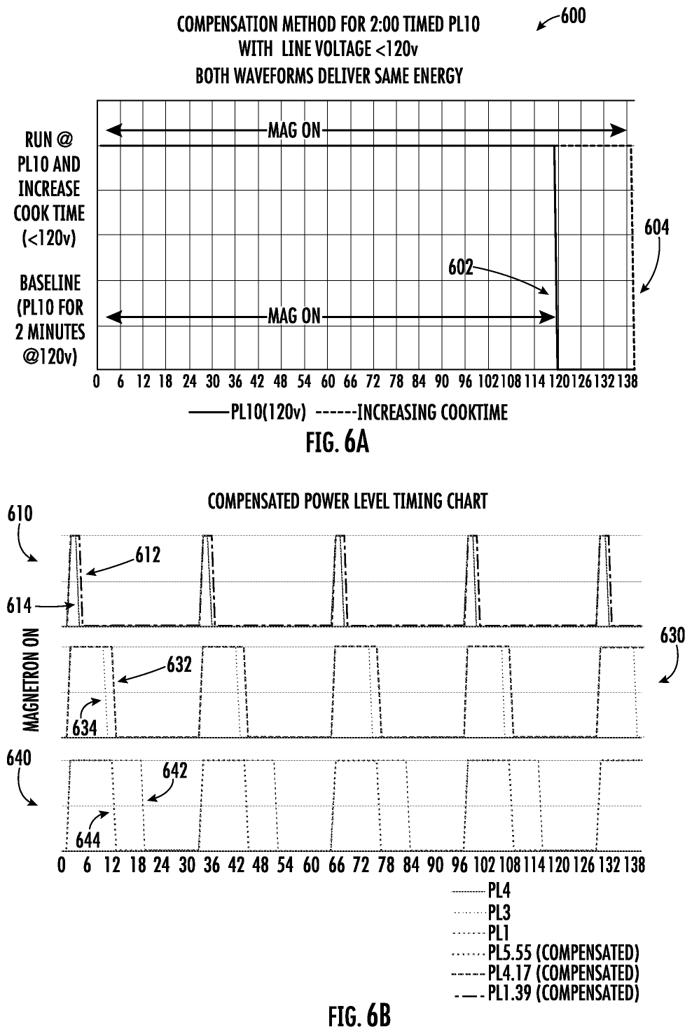

Referring now to FIG. 6A, an exemplary graph 600 depicting a magnetron activation time is provided. In graph 600, an exemplary cook program includes a baseline cook time relative to a nominal line voltage of 120 VAC of one-hundred and twenty (120) seconds at 100% power level (PL10), depicted at line 602. Method 1000 adjusts the duty cycle to increase magnetron ON time when the actual line voltage received is less than the nominal line voltage (e.g., less than 120 VAC), such as depicted at line 604. Method 1000 allows substantially the same output energy at PL10 with line voltage of 120 VAC for one-hundred and twenty (120) seconds as the adjusted duty cycle based on a reduced line voltage (e.g., less than 120 VAC) for one-hundred and thirty-eight (138) seconds.

Referring now to FIG. 6B, exemplary graphs 610, 630, and 640 depict magnetron activation times uncompensated and compensated in accordance with method 1000. Referring briefly to FIG. 5, method 1000 determines the actual received line voltage at the power supply is 102.3 VAC, such as depicted at point 504. The corresponding power output is approximately 72% of nominal power output. In graph 610, an exemplary cook program includes a baseline cook time relative to a nominal line voltage of 120 VAC of one-hundred and twenty (120) seconds at 10% power level (PL1), depicted at line 614. In graph 630, an exemplary cook program includes a baseline cook time relative to a nominal line voltage of 120 VAC of one-hundred and twenty (120) seconds at 30% power level (PL3), depicted at line 634. In graph 640, an exemplary cook program includes a baseline cook time relative to a nominal line voltage of 120 VAC of one-hundred and twenty (120) seconds at 40% power level (PL4), depicted at line 644. Method 1000 determines the compensated power levels by dividing the power level by the power output percentage. For instance, uncompensated PL4 with received line voltage at the power supply (e.g., 102.3 VAC) is compensated to PL5.55 (i.e., PL4 divided by 0.72); uncompensated PL3 with received line voltage at the power supply is compensated to PL4.17; uncompensated PL1 with received line voltage at the power supply is compensated to PL1.39. Accordingly, method 1000 adjusts the duty cycle to increase magnetron ON time when the actual line voltage received is less than the nominal line voltage (e.g., less than 120 VAC), such as depicted at line 612, 632, 634. Method 1000 allows substantially the same output energy at uncompensated PL1, PL3, and PL4 with line voltage at 120 VAC for the same period of time (e.g., 420 seconds) as the adjusted duty cycle based on the reduced line voltage (e.g., 102.3 VAC) for the same period of time at compensated PL1.39, PL4.17, and PL5.55, respectively.

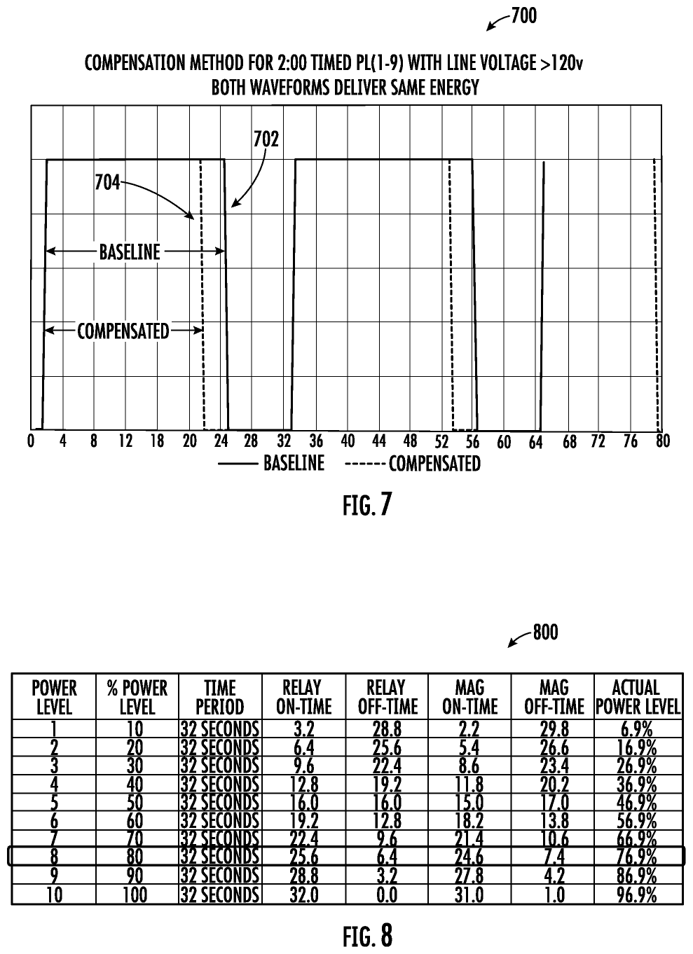

Referring now to FIG. 7, an exemplary graph 700 depicting a magnetron duty cycle in accordance with embodiments of the method 1000 is provided. In graph 700, an exemplary cook program includes a baseline duty cycle relative to a nominal line voltage of 120 VAC over a commanded cook time at a power level less than 100% (e.g., PL1, PL2, . . . PL9), depicted at line 702. Method 1000 adjusts the duty cycle to decrease magnetron ON time when the actual line voltage received is greater than the nominal line voltage (e.g., greater than 120 VAC), such as depicted at line 704. Method 1000 allows substantially the same output energy with the reduced magnetron ON time depicted at line 704 as the baseline duty cycle relative to the nominal line voltage. Accordingly, magnetron cycling is adjusted without requiring adjustment of the cook time to generate substantially similar output energy across the entire voltage range as may be received at the power supply.

In still various embodiments, method 1000 includes at 1050 determining a quantity of power supply cycles (e.g., magnetron cycles) based on a commanded cook time and a predetermined power supply timing cycle.

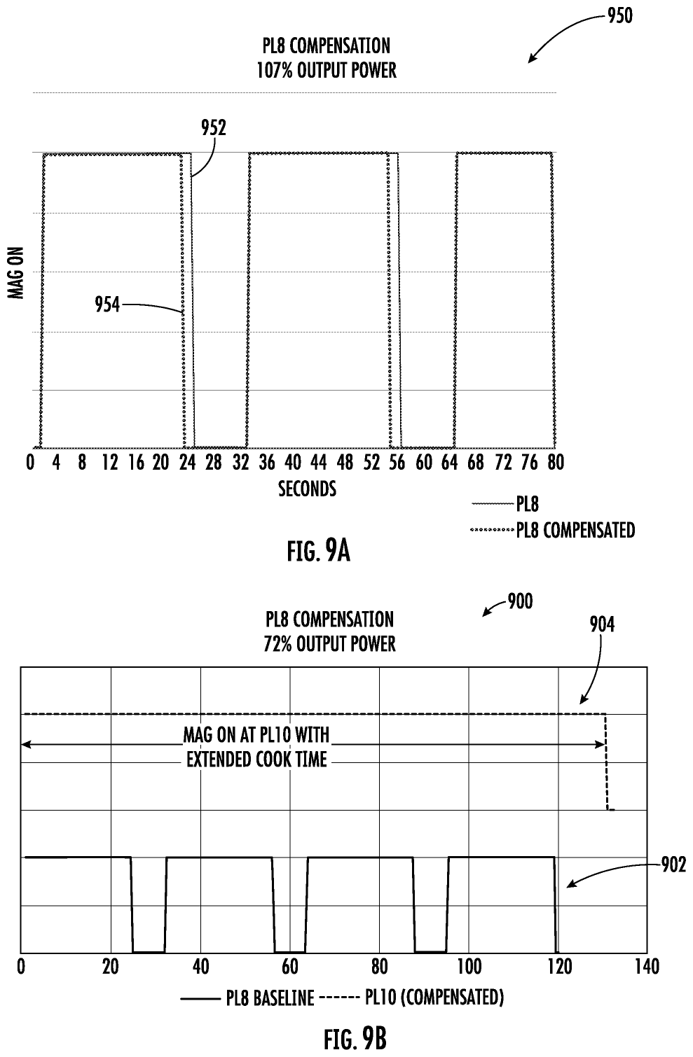

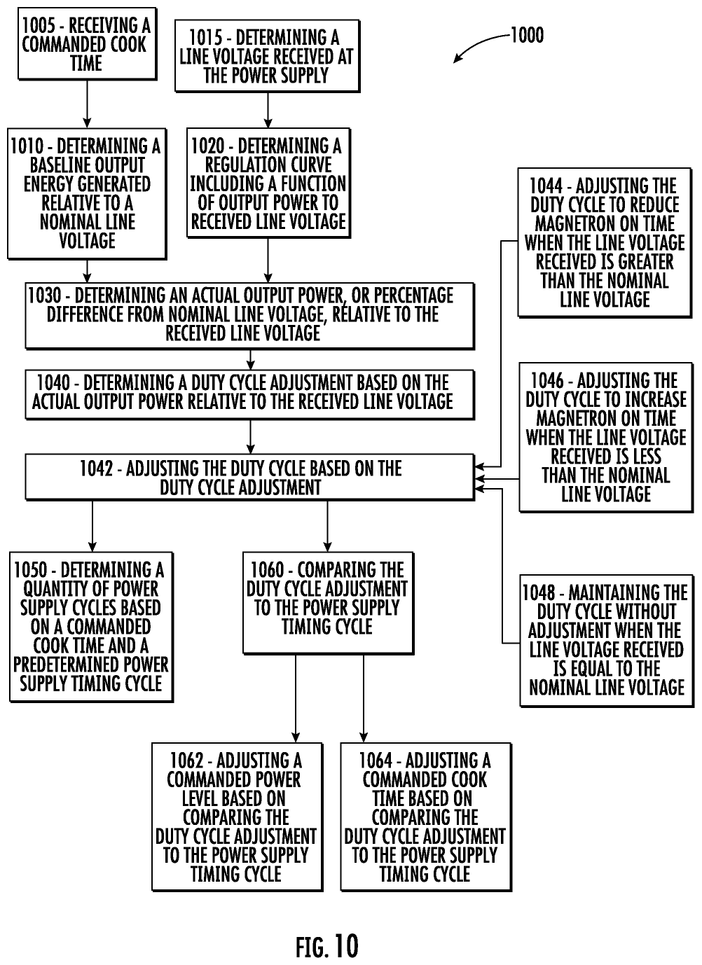

Referring now to FIG. 8, an exemplary table 800 depicting power levels versus relay ON/OFF times, magnetron ON/OFF times, and actual output power levels is provided. In an exemplary embodiment, a cook program includes an 80 second cook time at 80% power level (PL8). The microwave oven appliance is configured for a nominal line voltage of 120 VAC. The actual received line voltage at the power supply is 132 VAC. Referring briefly to FIG. 5, the oven magnetron power is approximately 107% of nominal (such as depicted at 504). In an exemplary embodiment, the microwave oven appliance is configured with a thirty-two (32) second magnetron timing cycle. Method 1000 at 1050 determines the quantity of power supply cycles based on the commanded cook time (e.g., 80 seconds) and the power supply timing cycle (e.g., 32 seconds) as being 2.5 cycles. Referring to FIG. 8A. graph 950 at line 952 depicts a nominal duty cycle at PL8. Table 800 provides a magnetron ON time per cycle of 24.6 seconds at PL8. Table 800 further provides an uncompensated magnetron OFF time per cycle of 7.4 seconds with a one (1) second delay, and an uncompensated magnetron ON time per cycle of 24.6 seconds, Method 1000 determines that an adjusted magnetron ON time per cycle by dividing the uncompensated magnetron ON time (e.g., 24.6 seconds) by the oven magnetron power percentage (e.g., approximately 107%). Method 1000 determines a compensated magnetron OFF time per cycle by determining a difference between the uncompensated and compensated magnetron ON times (e.g., a difference between 24.6 seconds and approximately 23.3 seconds) and adding the difference to the uncompensated magnetron OFF time (e.g., approximately 1.3 seconds plus 7.4 seconds). Accordingly, each full magnetron cycle includes approximately 23.3 seconds magnetron ON time and approximately 8.7 seconds magnetron OFF time, such as depicted at line 954 in FIG. 9A. Additionally, method 1000 determines that the adjusted half-cycle is approximately 14 seconds magnetron ON time (i.e., 16-second uncompensated half-cycle magnetron ON time divided by 107% actual output power). The remainder of the adjusted half-cycle is magnetron OFF time (e.g., difference between the 16-second uncompensated half-cycle magnetron ON time and the 14 second compensated magnetron half-cycle ON time).

Referring to FIG. 9B, an exemplary graph 900 depicting a magnetron duty cycle in accordance with embodiments of the method 1000 is provided. In an exemplary embodiment, a cook program includes an 80 second cook time at 80% power level (PL8). The microwave oven appliance is configured for a nominal line voltage of 120 VAC. The actual received line voltage at the power supply is 102.3 VAC. In an exemplary embodiment, the microwave oven appliance is configured with a thirty-two (32) second magnetron timing cycle. Method 1000 at 1050 determines the quantity of power supply cycles based on the commanded cook time (e.g., 80 seconds) and the power supply timing cycle (e.g., 32 seconds) as being 2.5 cycles. Graph 900 at line 902 depicts a nominal duty cycle at PL8. Table 800 provides a magnetron ON time per cycle of 24.6 seconds at PL8. Additionally, half of the 32-second power supply timing cycle is 16 seconds. Method 1000 at determines the actual output power from the received line voltage of 102.3 VAC is 72% of nominal output power. Method 1000 furthermore determines that the adjusted cycle is 34.17 seconds (i.e., 24.6 seconds magnetron ON time at PL8 divided by 72% actual output power). Additionally, method 1000 determines that the adjusted half-cycle is 22.2 seconds (i.e., 16-second half-cycle magnetron ON time divided by 72% actual output power).

Method 1000 may include at 1060 comparing the duty cycle adjustment to the power supply timing cycle. Method 1000 may include at 1062 adjusting a commanded power level based on comparing the duty cycle adjustment to the power supply timing cycle. Method 1000 may include at 1064 adjusting a commanded cook time based on comparing the duty cycle adjustment to the power supply timing cycle. Method 1000 at 1062 or 1064 may occur when the adjusted duty cycle is greater than the power supply timing cycle.

Referring back to the exemplary embodiment in regard to FIG. 8 and FIG. 9B, method 1000 at 1060 compares the duty cycle adjustment (e.g., 34.17 seconds) to the power supply timing cycle (e.g., 32 seconds). As the adjusted duty cycle is greater than the power supply timing cycle, method 1000 changes one or both of the commanded power level and the commanded cook time. In the exemplary embodiment, method 1000 changes the power level from PL8 to PL10. Additionally. method 1000 determines the adjusted cook time at the sum of adjusted power supply cycles (e.g., 34.17 seconds+34.17 seconds+22.2 seconds), for an adjusted cook time of 90.54 seconds. Graph 900 at line 904 depicts the adjusted duty cycle based on method 1000.

Embodiments of the microwave oven appliance 100 and method 1000 provided herein advantageously adjust a duty cycle, cook time, or both of a non-inverter power supply, such as a High Voltage Transformer, having a magnetron. Non-inverter power supply devices may generally have reduced complexity than inverters, which may allow for substantially reduced cost. However, non-inverter power supply devices are generally non-adjustable, such that line voltage to the power supply correlates directly to output power. Embodiments provided herein may overcome such non-adjustability to allow for consistent power output and result relative to a commanded cook time from a user or cook program. Furthermore, embodiments provided herein may provide consistent power output without requiring the complexity of inverter power supply devices, allowing for lower cost over microwave oven appliances including inverter power supply devices.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A microwave oven appliance, comprising:
a non-inverter power supply configured to receive a nominal line voltage, wherein variability in received line voltage varies output power from the power supply, the power supply comprising a relay configured to articulate operation a magnetron;
a sensor operably coupled to the power supply to determine received line voltage; and
a controller operably coupled to the power supply and the sensor, the controller configured to store instructions that, when executed, causes the microwave oven appliance to perform operations, the operations comprising:
measuring the received line voltage at the power supply;
determining a baseline output energy generated relative to the nominal line voltage;
determining an actual output power relative to the received line voltage;
determining a duty cycle adjustment based on the actual output power relative to the received line voltage;
adjusting the duty cycle based on the duty cycle adjustment to reduce magnetron ON time when the received line voltage is greater than the nominal line voltage;
adjusting the duty cycle based on the duty cycle adjustment to increase magnetron ON time when the received line voltage is less than the nominal line voltage; and
maintaining the duty cycle without adjustment when the line voltage received is equal to the nominal line voltage.

2. The microwave oven appliance of claim 1, the operations comprising:
determining a quantity of power supply cycles based on a commanded cook time and a power supply timing cycle, wherein determining the duty cycle adjustment is based further one the quantity of power supply cycles.

3. The microwave oven appliance of claim 1, the operations comprising:
comparing the duty cycle adjustment to a power supply timing cycle;
adjusting one or both of a commanded power level or a commanded cook time based on comparing the duty cycle adjustment to the power supply timing cycle.

4. The microwave oven appliance of claim 1, the operations comprising:
obtaining a commanded cook time, wherein adjusting the duty cycle based on the duty cycle adjustment maintains the commanded cook time unchanged at a display component.

5. The microwave oven appliance of claim 1, wherein determining the baseline output energy generated relative to the nominal line voltage comprises comparing the received line voltage to a regulation curve.

6. The microwave oven appliance of claim 5, wherein determining the actual output power relative to the received line voltage comprises comparing the received line voltage to the regulation curve.

7. The microwave oven appliance of claim 5, wherein the regulation curve is a function of output power to received line voltage.

8. The microwave oven appliance of claim 1, wherein the non-inverter power supply is a high voltage transformer.

9. A method for operating a microwave oven appliance comprising a non-inverter power supply, the method comprising:
measuring a received line voltage at a non-inverter power supply;
determining a baseline output energy generated relative to a nominal line voltage;
determining an actual output power relative to the received line voltage;
determining a duty cycle adjustment based on the actual output power relative to the received line voltage; and
reducing or increasing magnetron ON time based on the duty cycle adjustment.

10. The method of claim 9, the method comprising:
determining a quantity of power supply cycles based on a commanded cook time and a power supply timing cycle, wherein determining the duty cycle adjustment is based further one the quantity of power supply cycles.

11. The method of claim 9, the method comprising:
comparing the duty cycle adjustment to a power supply timing cycle for the non-inverter power supply; and
adjusting one or both of a commanded power level or a commanded cook time based on comparing the duty cycle adjustment to the power supply timing cycle.

12. The method of claim 9, the method comprising:
obtaining a commanded cook time, wherein reducing or increasing magnetron ON time based on the duty cycle adjustment maintains the commanded cook time unchanged at a display component of the microwave oven appliance.

13. The method of claim 9, wherein determining the baseline output energy generated relative to the nominal line voltage comprises comparing the received line voltage to a regulation curve.

14. The method of claim 13, wherein determining the actual output power relative to the received line voltage comprises comparing the received line voltage to the regulation curve.

15. The method of claim 13, wherein the regulation curve is a function of output power to received line voltage.

16. A controller for a microwave oven appliance, the controller operably coupled to a non-inverter power supply and a sensor configured to determine received line voltage, the controller configured to store instructions that, when executed, causes the microwave oven appliance to perform operations, the operations comprising:
measuring a received line voltage at a non-inverter power supply;
determining a baseline output energy generated relative to a nominal line voltage;
determining an actual output power relative to the received line voltage;
determining a duty cycle adjustment based on the actual output power relative to the received line voltage; and
reducing or increasing magnetron ON time based on the duty cycle adjustment.

17. The controller of claim 16, the operations comprising:
determining a quantity of power supply cycles based on a commanded cook time and a power supply timing cycle, wherein determining the duty cycle adjustment is based further one the quantity of power supply cycles.

18. The controller of claim 16, the operations comprising:
comparing the duty cycle adjustment to a power supply timing cycle; and
adjusting one or both of a commanded power level or a commanded cook time based on comparing the duty cycle adjustment to the power supply timing cycle.

19. The controller of claim 16, wherein determining the baseline output energy generated relative to the nominal line voltage comprises comparing the received line voltage to a regulation curve.

20. The controller of claim 19, wherein determining the actual output power relative to the received line voltage comprises comparing the received line voltage to the regulation curve.
